(19) United States
(12) Patent Application Publication
(10) Pub. No.: US 2008/0099654 A1
(43) Pub. Date: May 1, 2008

(54) GUIDE PACKING DEVICE FOR TELESCOPIC COLUMNS IN PARTICULAR FOR LIFTING APPARATUS

(75) Inventors: Jean-Marc BAILLY, Ambierle (FR); Denis Narelli, Saint Haon Le Chatel (FR); Christophe Valette, Saint Bonnet De Cray (FR)

Correspondence Address: HESLIN ROTHENBERG FARLEY & MESITI PC, 5 COLUMBIA CIRCLE, ALBANY, NY, 12203, US

(73) Assignee: ROGER MONDELIN SAS, Ambierle (FR)

(21) Appl. No.: 11/925,005

(22) Filed: Oct. 26, 2007

(30) Foreign Application Priority Data
Oct. 31, 2006 (FR) 0654678

(51) Int. Cl. F16M 7/00; B66C 5/00

(52) U.S. Cl. 248/644; 52/111

(57) ABSTRACT

The device comprises combinations of two subsets of guide packings. Each combination has a profile matching an upper internal and lower external profile of each a respective telescopic profiled element, forms a one-piece nipple, and comprises an internal and external surround for cooperating with upper and lower front end edges, respectively in the internal cavity of the respective telescopic profiled element for upper guidance and on the exterior of the respective telescopic profiled element for lower guidance, Each packing has a surround with slots. Each slot receives a stud hinged and joined to the surround to be incorporated and positioned by elastic deformation in an opposing opening. Around these slots receiving studs, a zone is arranged for supporting and guiding another telescopic profiled element.

CROSS REFERENCE TO RELATED APPLICATIONS

This application claims priority from French patent application No. 0654678, filed on Oct. 31, 2006, the entire disclosure of which is incorporated herein by reference.

### BACKGROUND ART

The invention relates to the technical field of guide means for telescopic elements incorporating lifting apparatus for miscellaneous applications, and in particular, in the building and construction field.

Telescopic elements are found, for example, on board and plate lifting apparatus for presenting them against walls and/or ceilings. The telescopic elements are accordingly in the form of metal or other profiles fitting into one another, for example to obtain a maximum development of the vertical clearance allowing the placement of boards of plaster or other materials. The useful development length is therefore about 3 metres, and several profiles are necessary. In practice, there is one external assembly profile having a generally U shaped or rectangular configuration, and the other internal profile or profiles fit into one another. Travel limiting means are used for the two maximum development or non-development situations.

To permit the guiding of the telescopic profiles (P) internally, packings (G) of elastomer are used. These profiles are accordingly perforated near their upper and lower ends with the formation of holes passing though the thickness of the said profiles.

The packings thus have a plane rectangular base with a circular configuration projection forming a plug, and being suitable simultaneously for fitting into the matching hole assigned to it. In practice, each packing is thus mounted internally into the profile, its finger or stud serving for fixing and positioning and the outer face of the base serving for the passage and guidance of the sliding internal profile. FIG. 1 thus shows such a packing before mounting on a profile, in relation to the prior art.

In practice, for each profile, there are 16 packings of this type, 8 placed in the upper part of the profile and 8 in the lower part. If the telescopic structure comprises three profiled elements, there are then 48 packings.

This technique is widely used by the Applicant in its particular application for lifting apparatus and for positioning boards or plates, and also by other manufacturers. In practice, the use of such packings has many drawbacks.

A first drawback resides in the need to manually position the different packings inside the profiles concerned, and in doing this correctly to avoid their accidental removal, and this requires a relatively long mounting time.

Another drawback resides in the high risk of the said packings escaping from their housing during the insertion of the profiles into one another, because these packings, internally projecting from the inside walls of the receiving profiles, can constitute blocking and hooking zones. The thrust exerted on the profiles accordingly causes their ejection from the receiving hole and their loss. This is followed by an imbalance in the guidance of the profiles together.

In a situation of use of the lifting apparatus, due to the different handlings, the vibrations and the environmental conditions, in the case in which the packings have been poorly positioned in their housing, it is possible for the said packings to fall from their housing with the aforesaid risks and drawbacks.

All of these drawbacks have thus led the Applicant to reflect on a novel type of packing for telescopic elements which is safer, easier to assemble and disassemble, and above all, without any risk of escape.

The initial researches were focused on the possibility of an improved manner for fixing the guide packings used according to the prior art by an optimization of the anchorage by configurations for clipping the fingers in their housing, or by a mounting, by cementing or self-fastening material on the inside or outside face of the profiles. Another research direction was to arrange the profiles at the receiving locations with specific grooves, but this demanded inappropriate machining operations.

All these research directions were abandoned, because inappropriate, ineffective, sometimes difficult to implement and costly.

The solution provided by the Applicant goes in a different direction to current practice, and provides a simplification in the assembly, a speed therein, safety with the impossibility of escape from the housings, while being economically inexpensive.

### BRIEF SUMMARY OF THE INVENTION

According to a first feature, the device for mounting guide packings for telescopic elements for lifting apparatus, of the type in which the telescopic elements are arranged in their upper and lower part with openings forming a housing for matching anchor studs on the guide packings, is remarkable in that it comprises combinations of two subsets of packings having a profile matching the upper internal profile of each telescopic element forming a one-piece nipple, and comprising an internal surround for fitting the upper front end edges into the internal cavity of the said telescopic profiled element, or matching the lower external profile of each telescopic element forming a one-piece nipple, and comprising an external surround for the telescopic profiled element to fit into the internal cavity of said one-piece nipple, and in that the nipple constituting each packing is arranged on its internal surround with slots and each receiving a stud and hinged and joined to the said surround to be incorporated and positioned by elastic deformation in the openings forming a housing established opposite the upper end lower parts of the matching telescopic profile, and in that around these slots receiving studs, a zone is arranged for supporting and guiding another profile.

These features and others will clearly appear from the rest of the description.

### BRIEF DESCRIPTION OF THE DRAWING FIGURES

To clarify the subject matter of the invention illustrated in a non-limiting manner in the figures of the drawings appended hereto:

FIG. 1 is a view showing a guide packing before mounting used for telescopic elements of lifting apparatus by the Applicant according to the prior art.

FIG. 2 is a perspective view of the guide device according to the invention in its version suitable for the upper part of the telescopic profiles.

FIG. 2a shows a cross section along line A-A of FIG. 2.

FIG. 3 is a perspective view of the guide packing device of the invention in its version suitable for the lower part of the profiles, the said version having a functional form equivalent to the use of the packings for the upper part of the telescopic profiles.

FIG. 3a shows a cross section along line B-B of FIG. 3.

FIG. 4 is a partial view of several telescopic profiles assembled with the use of assembly packings in the upper part of the said profiles.

FIG. 5 is a partial view showing the assembly of the packings in the lower part of telescopic elements.

FIG. 6 is a partial view and cross section of the assembly of the telescopic profiles with the guide packings according to FIG. 4.

FIG. 7 is a partial view and cross section of the assembly of the telescopic profiles with their guide packing according to FIG. 5.

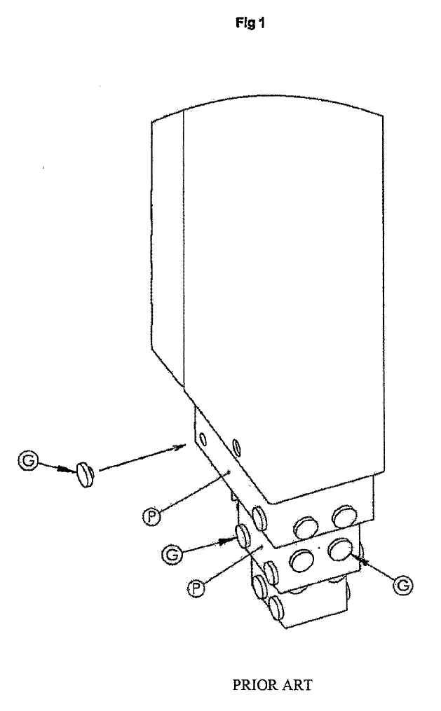

### DETAILED DESCRIPTION

To make the subject matter of the invention more concrete, it is now described in a non-limiting manner shown in the Figures of the drawings.

The guide packing device (D) of the invention can be applied to any assembly and apparatus including telescopic elements in the form of metal profiles, for example. These apparatus may, for example, be lifting and handling apparatus for large boards or plates to be presented and positioned on the walls or ceilings of any type of structure. These telescopic elements may be present in a variable number according to the lifting capacity of the apparatus concerned, and also the length of each telescopic element. Also shown is one example of telescopic profiles of a metal or other material with an open and/or closed rectangular profile according to the applications.

The guide packing device according to the invention is thus profiled to closely match the dimensional and geometric configuration of the receiving telescopic elements. A guide packing device of the invention is thus shown with upper and lower packing combinations with a rectangular configuration to adapt to the matching shapes of the rectangular telescopic profiles in the example illustrated.

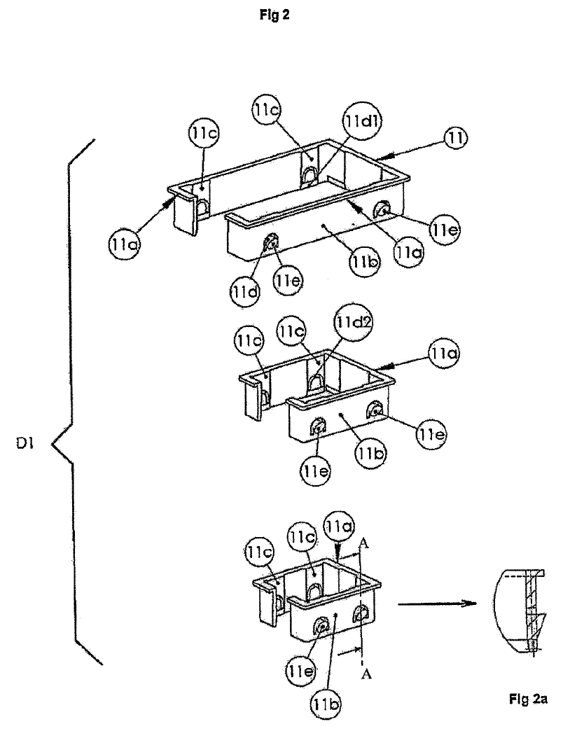

The guide packing device is referenced as a whole by (D) and comprises a first subset of packings (D1) for being positioned and fixed from the upper frontal edges (1a) (1b) (1c) of the telescopic elements (1) (2) and (3), and a subset of packings (D2) for being positioned and fixed from the lower frontal edges (2a) (2b) (2c) of the said telescopic elements (1) (2) and (3). Each subset (D1) (D2) comprises a number of guide packings according to the number of telescopic elements existing in the apparatus, but each packing has the same functional configuration for each subset, and only the dimensional differences appear. A single upper guide packing and a single lower guide packing are described below. Reference is thus made to FIG. 2 for the representation of a set of three upper guide packings according to the invention. Each packing (11) is capable of constituting a one-piece plastic nipple for being inserted from the upper frontal edge of the telescopic profile concerned. This nipple is closed or partially opened according to the configuration of the profile. In the present case, the profile having a rectangular shape with the passage opening on one side, the nipple is made identically. The nipple (11) has an upper border (11a) for bearing on the receiving peripheral edge of the profile and a lower peripheral surround (11b) perpendicular to the edge and being suitable for fitting into the receiving profile. This surround (11b) internally has two vertical wall portions (11c) on each face capable of constituting zones for the support and guidance of another profile. Inside each of them, half-moon openings (11d) are provided in the thickness of the surround, for example with a horizontal base line (11d1) above a semi-circular configuration (11d2). Each opening (11d) is associated with a stud (11e) which is connected during the fabrication to the base line (11d1) and is incorporated in the housing thus prepared of the said opening. This stud is, for example, cut out of the material of the nipple to match it during the fabrication of the nipple, which is obtained by thermoforming in particular. Each stud therefore has an elastic pivoting capacity, being either vertical incorporated in the opening (11d) during the insertion of the nipple into the profile by the contact with the opposite internal face of the profile, or separating radially externally when the stud is positioned opposite of the receiving opening (11d), no longer being retained. This evidence is a position locking when the nipple is mounted. Thus, depending on the implementation, the various studs absolutely do not hinder the guide part (11c) being separated therefrom. Each guide packing prepared in nipple form comprises eight studs placed in pairs in the corner part of each nipple thereby producing two studs per face, for a complete guidance. The positioning of these sets of packings is therefore particularly easy.

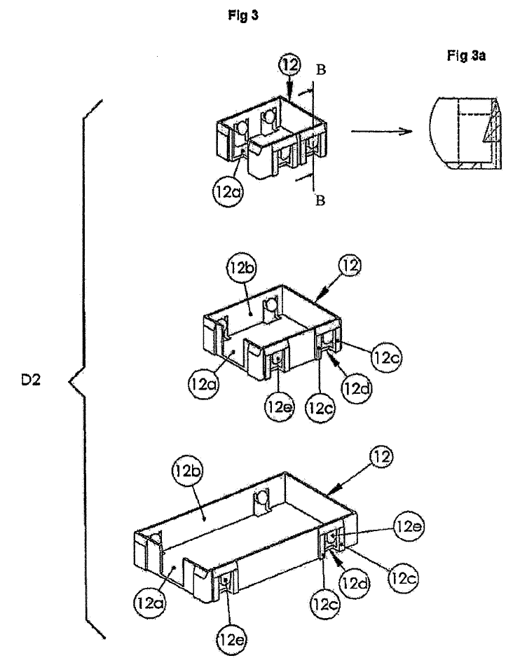

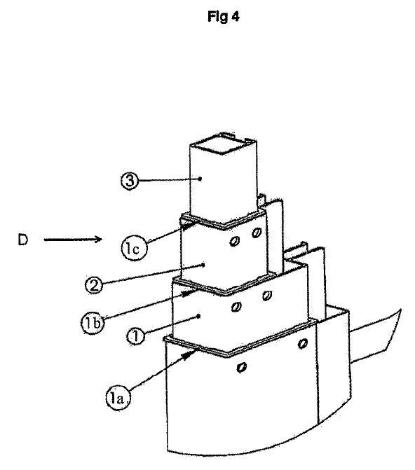

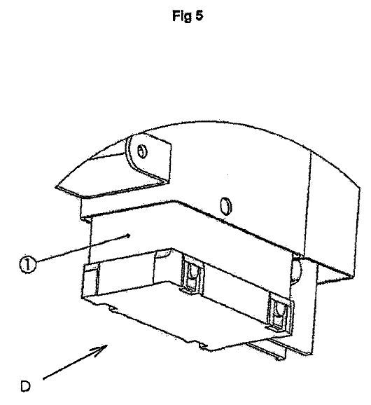

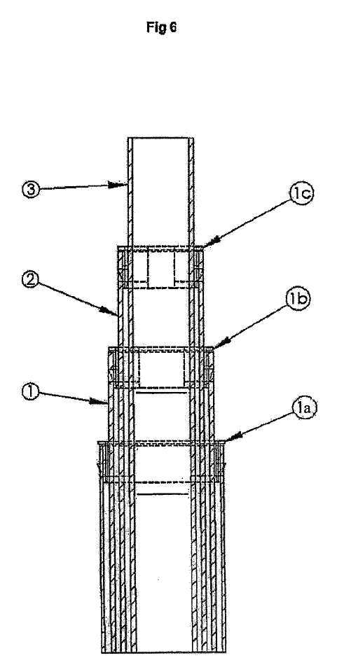

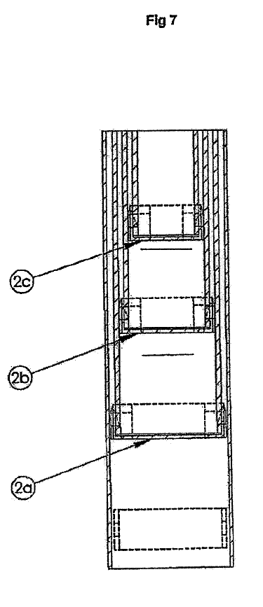

Now referring to FIG. 3, a single guide packing of the second subset (D2) is described. Similarly, each lower packing consists of a second nipple (12) whereof the matching profile fits into the interior of the said nipple. The said second nipple comprises an end phase (12a) and a peripheral surround (12b) closed or partially open according to the configuration of the receiving telescopic profile. On said surround and externally, zones for support and external guidance (12c) are provided against the internal wall opposite the profile and which is suitable for surrounding the said nipple receiving profile. On either side of this support zone, openings (12d) for passing through the thickness of the nipple and from which studs (12e) are conformed and hinged to take position in the openings thus conformed for this purpose on the profile. The implementation is similar to that described for the upper packings. The said studs are thus connected by a fastening and joining line with the upper part of the said openings (12d).

Thus this second nipple receives the portion of the telescopic profile and the studs house and lock the second nipple in position in the receiving profile concerned. The second nipple also comprises eight studs placed in pairs in the corner parts of each nipple (12) with two studs per face, for complete guidance.

The positioning of the two nipples (11) and (12) is therefore in itself sufficient for the guide packing device of the invention to offer many advantages.

For a telescopic apparatus with three profiles according to the prior art, 48 packings were used with the drawbacks described in the preamble to the description. According to the invention, three upper packings (D1) and three lower packings (D2) are sufficient for obtaining the same result with greater safety of use.

The packings are made from elastic by thermoforming for example, hence with low fabrication costs. Positioning is extremely rapid. There is no risk of loss and hence of interrupted guidance, because the packings are themselves locked in position by the corresponding studs. A specific effort must be made to unlock them and to release the said studs from the housing zone. In practice, similar forces would have to be exerted on the four studs, which is therefore inconceivable. Safety is therefore substantially improved.

1. Device for mounting guide packings for telescopic profiled elements for lifting apparatus, wherein an upper part and a lower part of the telescopic elements are arranged in with openings forming a housing for matching anchor studs on the guide packings, comrising combinations of two subsets of guide packings each combination having a profile matching an upper internal and lower external profile of a respective telescopic profiled element, each guide packing and forming a one-piece nipple, each combination comprising an internal and external surround for cooperating with upper and lower front end edges, respectively in an internal cavity of the respective telescopic profiled element for upper guidance and on an exterior of the respective telescopic profiled element for lower guidance, each packing having a surround with slots, each slot receiving a stud hinged and joined to the surround to be incorporated and positioned by elastic deformation in the openings forming a housing and wherein around the slots receiving studs, a zone is arranged for supporting and guiding another telescopic profiled element.

2. Device according to claim 1, wherein each guide packaging of a first subset of said two subsets has an upper border for bearing on a receiving peripheral edge of the respective telescopic profiled element and a lower peripheral surround perpendicular to the edge for fitting into the internal cavity of the respective telescopic profiled element, the peripheral surround internally has two vertical wall portions located around the studs constituting zones for support and guidance of another telescopic profiled element, and inside the wall portions, half-moon openings are provided in a thickness of the peripheral surround with a horizontal base line above a semi-circular configuration, and each half-moon opening is associated with a stud which is connected during fabrication to the base line and is incorporated in a housing of said half-moon opening, and each stud has an elastic pivoting capacity.

3. Device according to claim 1, wherein each guide packing of a second subset of the two subsets comprises an end phase and a peripheral surround closed or partially open according to a configuration of the respective telescopic profiled element, external zones for support and guidance are provided externally on the peripheral surround, and on either side of an external zone, openings are provided passing through a thickness of the peripheral surround and from which the studs are conformed and hinged to take position in the openings forming a housing, and wherein the studs have an elastic pivoting capacity.

4. Device according to of claim 1, wherein each nipple comprises eight studs located in pairs in corner portions of the nipple, two studs being placed on each face.

5. Device according to claim 1, wherein the packings are made from one-piece plastic and by thermoforming.
